(19) United States
(12) Patent Application Publication
(10) Pub. No.: US 2016/0018814 A1
(43) Pub. Date: Jan. 21, 2016

(54) Method for Balancing a Rotating Part in Order to Produce a Machined and Balanced Rotating Part

(71) Applicant: VIDEOMETRIC, Les-Martres-de Veyre (FR)

(72) Inventor: Bernard Peuchot, Les Martres-de-Veyre (FR)

(21) Appl. No.: 14/655,770

(22) PCT Filed: Jan. 9, 2014
(86) PCT No.: PCT/FR2014/050029

§ 371 Date: Sep. 21, 2015

(30) Foreign Application Priority Data
Jan. 14, 2013 (FR) 1350297

(51) Int. Cl. G05B 19/4099

(52) U.S. Cl. CPC G05B 19/4099; G05B 2219/36204

(57) ABSTRACT

A method for balancing a rotating part in order to produce a machined and balanced rotating part, from a blank of a rotating part comprising a step of virtual machining of the digital model of the blank, so as to calculate an intermediate digital model in the target reference frame comprising the motor shaft; at least one step of modifying the geometric reference frame of the digital model of the blank in order to make the axis of inertia of the intermediate digital model match the nominal axis of rotation of the motor in the target reference frame; steps of iterative calculation of the previous steps until the discrepancy between the calculated axis of inertia and the nominal motor shaft is lower than a threshold value; and the final step consisting of controlling an actual machining apparatus.

### BACKGROUND

The present invention relates to the field of machining a mechanical rotating part using a machining apparatus controlled by a digital control.

Rotating parts are, for example, and not restrictively, electric motor crankshafts or rotors, turbines, etc.

Rotating parts have some machined areas with low tolerances and some areas with lower constraints, which makes it possible to adjust the dimensions with the aim of achieving perfect balance of the rotating part.

In the following description, the invention is described in the case of the manufacturing of a balanced crankshaft, without this restricting the protection to crankshafts only.

For a crankshaft, the machined areas with low tolerances (typically of about five microns) are, for instance, the bearing housings and the crank pins, the positioning and the dimensions of which must be very precise to be able to comply with the motor manufacturing and operation constraints. This may also concern bores or areas subject to specific machining. Such machined areas are connected by areas with a relaxed tolerance (typically of the order of one millimeter or more) simply corresponding to passing constraints in the engine block.

Such areas can be adjusted to improve balancing of the crankshaft, typically by removing material, in the current industrial processes.

In the prior art, balancing is achieved by removing material in the areas with relaxed tolerance, as directed by the balancing machine: a crankshaft is produced, it is mounted on a balancing stand for measuring its imbalance, and then the indicated material removal is executed, until the measure on the stand is satisfactory. The selected removal areas and the amount of material to be removed are indicated by the mechanical balancing stand. The material is removed, for example, by drilling the designated areas, typically in the counterweights which correspond to areas with relaxed tolerance.

Mechanical balancing solutions are known in the prior art. Such a solution is for example described in US patent application US2003230142 and U.S. Pat. No. 4,545,341.

French patent FR2797314 is also known, which relates to a method for machining a crankshaft of the same type as the one comprising the following main steps: determining the starting points, —machining the ends, bearings and crank pins, —providing oil holes, finishing the ends, bearings and crank pins, —dynamic measurement and if required removing material for balancing purposes, characterized in that it consists in executing the operations of dynamic measurement of the masses and removing material for balancing purposes, prior to the finishing operations.

Solutions are also known in the prior art which aim at avoiding the successive adjustments, thanks to a preparation of a file for controlling a processing machine, to obtain a rotating part having a satisfactory balance in a single step.

European Patent EP1760443 thus describes a method for balancing crankshafts comprising parts machined at the ends of the axes A, B, crank pins, journals and counterweights, characterized in that:
a reference crankshaft of a type to be obtained from the customer database is digitally designed.
a crankshaft is manufactured which is then analyzed in a stereovision system by identifying a multitude of image points in space so as to rebuild the actual three-dimensional surface limiting the volume thereof and the axis of inertia is deduced therefrom.
the reference crankshaft and the manufactured and viewed crankshaft are then compared, by digitizing: verification of conformity/dimensional tolerances thereof.
the virtual machining/axis of inertia thereof, as calculated previously is performed by digital processing.
the new axis of inertia/new weight distribution resulting from one machining are then calculated.
the ends of the crankshaft are eventually faced, on a machine, and the center holes materializing the ideal axis of inertia are drilled.

European Patent EP2305420 relating to a method for determining a center hole of rotation is also known.

Another document of the prior art, Japanese Patent JP2007264746 describes a method for accurately calculating the center of rotation of a rotating part, consisting in measuring the three-dimensional shape of a pre-work and then in carrying out the following processing:
a step of preparing the finished form, after rotation forming of a work by simulation,
a step of excluding any excess section of the three-dimensional pre-work obtained by measuring the finished form on the basis of the simulation,
and a step of calculating the center of rotation of the form excluding the excess section.

The prior art solutions are not satisfactory because the methods implementing successive mechanical adjustments are empirical, require long and tedious operations and do not always converge to a perfectly balanced part.

The solution provided in patent EP1760443 is not satisfactory either since it is based on an unsuitable design model when the initial blank has large imperfections. In these cases, the part obtained requires additional adjustments.

### SUMMARY

The present invention aims at remedying the disadvantages of the prior art by providing a method for preparing a file for controlling the machining apparatus ensuring a satisfactory balance by reducing the additional finishing-machining times, even when the original blank has significant imperfections.

For this purpose, the present invention relates, in its broadest sense, to a method for balancing a rotating part in order to produce a machined and balanced rotating part, comprising areas machined with high tolerance (bearings, bearing housings, . . . ) and areas with low tolerance, whether machined or not (rough surfaces, . . . ),

from the blank of a rotating part on the one hand, and a nominal digital model of the machining constraints of the machined areas with high and low tolerances of a nominal rotating part on the other hand
said method comprising an initial step of digitizing said blank for obtaining a digital model of said blank, in a predetermined reference frame
a first step of virtual machining said digital model of the blank, so as to calculate an intermediate digital model in the target reference frame of a rotating part machined from the digital model of the blank on the one hand, and the nominal digital model of the machining constraints on the other hand,
a step of determining the axis of inertia of said intermediate digital model
at least one step of modifying the digital geometric reference frame of said digital model of the blank so as to match said axis of inertia of said intermediate digital model with the nominal axis of rotation of the motor in the target reference frame
steps of iterative calculation of the previous two steps until the discrepancy between the calculated axis of inertia and the nominal motor shaft is lower than a threshold value
the final step consisting in controlling an actual machining apparatus in the target reference frame, from the nominal digital model of the machining constraints on the actual blank positioned on the machining apparatus in accordance with the intermediate digital model resulting from the last iteration.

Such method leads to a result favoring the optimal positioning of the part on the machining apparatus by limiting at most the removing of material, while the solutions of the prior art are based on an approximate positioning, and a compensation by removing material.

Advantageously, said step of modifying the geometric reference frame consists in recalculating a translation vector [Tx, Ty, Tz] as well as the three Euler angles [Ax, By, Gz] or any other instruction using the alternative conventional methods such as for instance the quaternions.

According to a particular embodiment, the method comprises:
a step of producing a rough part,
a step consisting in digitizing such part and obtaining the rough model of such part,
a step of initializing a translation vector [Txᵢ, Tyᵢ, Tzᵢ] and the three Euler angles [Axᵢ, Byᵢ, Gzᵢ] corresponding to the initial positioning of the digital model determined during the step
a step of calculating a virtual model using a process consisting in moving the rough model according to the transformation of the rigid body previously defined by the vector [Txᵢ, Tyᵢ, Tzᵢ] and the rotation angles [Axᵢ, Byᵢ Gzᵢ]
a step of virtual machining consisting in applying the machining instructions as digital data to the virtual model repositioned during the previous step
a step of calculating the axis of inertia from the abovementioned intermediate virtual part
a step of comparing the calculated axis of inertia with the motor shaft and modifying, during a step of adjusting the vector [Tx, Ty, Tz] as well as the rotation angles [Ax, By, Gz] so as to determine a new position determined by a vector [Txⱼ, Tyⱼ, Tzⱼ] and by the Euler angles [Axⱼ, Byⱼ, GZⱼ], optimized according to a method for optimizing and iterating the set of processing operations corresponding to the preceding steps.

According to a particular mode of implementation, the method according to the invention comprises steps of calculating the balancing in a limited portion and, if this balancing appears imperfect, of determining an additional machining constraint in addition to original virtual machining, for removing material with the aim of balancing said local portion.

According to one particular alternative embodiment, new iterations, taking into account such model with the additional machining operations, are executed after the calculation of the local balancing.

The invention also relates to a machining apparatus comprising a processor controlled by a digital control obtained by implementing the abovementioned method.

It also relates to a computer program for implementing such method and a computer-readable recording medium having a computer program for implementing the method.

### BRIEF DESCRIPTION OF THE DRAWINGS

The present invention will be better understood upon reading the detailed description which follows, which relates to a non-limiting exemplary implementation, with reference to the appended drawings wherein:

FIGS. 1 to 5 show schematic views of the successive steps implemented in the prior art

FIGS. 6 and 7 show schematic views of the successive steps implemented in the method according to the invention

FIG. 8 is a block diagram of the digital processing of the invention.

### KNOWN METHOD

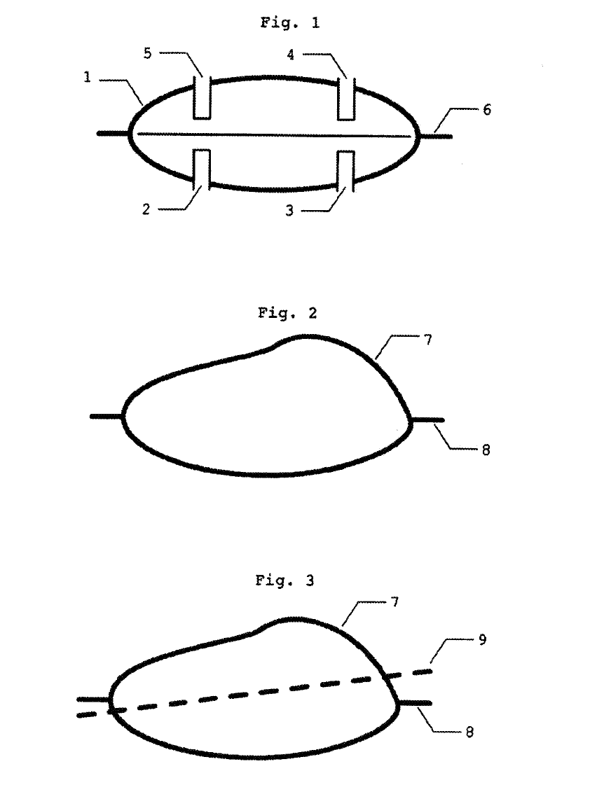

The solution proposed in patent EP1760443 is illustrated in FIGS. 1 to 5.

The first step consists in digitally designing a typical reference crankshaft of the type to be obtained on the basis of customer data.

Such customer data are shown in FIG. 1. Such customer data are constituted by a three-dimensional computer model determining the reference geometry of the crankshaft schematized by the required outline 1 and machining operations 2 to 5.

Such a digital model determines the high stress areas 2 to 5, and the other areas which may be the subject of modifications aiming at balancing. Such a model is used to determine the motor shaft 6 imposed by the architecture of the engine which such crankshaft is intended for.

The next step, according to this prior art, consists in “digitally designing a crankshaft which is then analyzed in a stereovision system by identifying a multitude of image points in space so as to rebuild the actual surface in three dimensions, limiting its volume”.

Such step is illustrated in FIG. 2 which shows the geometry of the rough part, resulting from the manufacture by forging or casting (or any other means). Such geometry of the rough part is schematically shown by the outline 7, with an indication of the digitizing axis 8.

The method then provides to “deduce its axis of inertia from the rough part, and compare by digital processing with the virtual machining thereof with respect to the axis of inertia [calculated during the previous step]”.

FIG. 3 illustrates this step by pointing the calculated axis of inertia (9) and the positioning thereof relative to the digitizing axis 8 and the outline 7 of the rough part.

The next step, according to the prior art consists in subsequently comparing, by digitizing, the reference crankshaft with the manufactured and viewed crankshaft: verification of its compliance with the dimensional tolerances, and then executing, through digital processing, its virtual machining/axis of inertia, as calculated previously.

Such step is illustrated in FIG. 4.

It consists in calculating a three-dimensional digital representation determining the geometry of the virtually machined part, represented schematically by the virtual machining areas 12 to 15 and an outline 17 resulting from the virtual machining.

The same FIG. 4 also represents the ideal axis of inertia 10 obtained during the step of calculating the new axis of inertia/new weight distribution resulting from the machining. This ideal axis 10 is, still according to the prior art, used for finishing the ends of the crankshaft and drilling the center holes 18, 19 materializing the ideal axis of inertia 10.

Such method of the prior art makes it possible to control a machining apparatus around the so-called “ideal” axis 10, materialized by the two holes 18, 19. FIG. 5 shows the result of such mechanical machining, controlled by the file resulting from the processing according to the known methods:

This leads to the execution of machining operations 22 to 25 which turn out not to perfectly match the virtual machining areas 12 to 15, due to the discrepancy between:
the coordinate system wherein the virtual machining areas 12 to 15 have been calculated
the coordinate system wherein the actual machining areas 22 to 25 have actually been provided.

The result is, on the one hand, an error in the positioning of the machining areas, which is unacceptable because of the very low tolerances acceptable for these areas, and on the other hand an approximate balancing which is not fully consistent with the objectives. Such anomalies are all the more important since the original rough part is very far from the nominal geometry. In summary, the known method is applicable only to original rough parts already very close to the nominal geometry.

### DETAILED DESCRIPTION

The method according to the invention takes into account the same initial data as the above solution, which corresponds to FIGS. 1 and 2.

But it is basically different by the processing operations which are then performed to prepare the controlling of the mechanical machining apparatus. In particular, the method according to the invention does not take into account a “calculated axis of inertia 9” nor “its positioning relative to the digitizing axis 8 and the outline 7 of the rough part”.

On the contrary, the method according to the invention consists in executing a virtual machining in the machining reference system comprising the motor shaft 6. All the digital processing operations implemented by the invention are carried out in that reference system comprising the motor shaft 6, and not in a coordinate system comprising a calculated axis of inertia 9.

The processing operations carried out by the invention are iterative on the digital representation of the rough part 7 in an intermediate position.

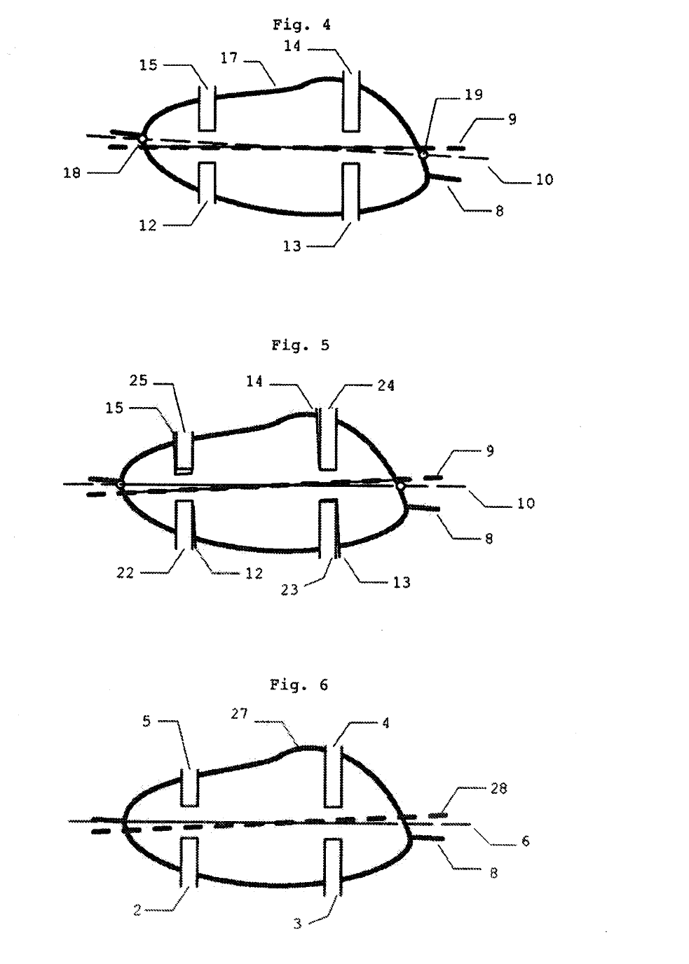

A digital processing as illustrated in FIG. 6 is first carried out, which consists in calculating a virtual geometry of an intermediate part corresponding to the virtual machining 2 to 5, in strict conformity with the required machining operations, in the motor reference 6 without any transformation of such machining operations.

Such calculation of the machining is executed on the representation of the rough part 27, the geometry of which corresponds to that of the digitized rough part 7 and the orientation of which varies during the iterations.

The next step consists in calculating the axis of inertia 28 from the representation of the rough part 27 virtually machined with the areas 2 to 5.

So long as the axis of inertia 28 does not correspond to the motor shaft 6, the orientation of the rough part 27 is modified relative to the motor shaft 6, in order to carry out a new step of the aforementioned virtual machining.

Such modifications are consistently executed to tend toward a reduction to the minimum discrepancy between the virtual axis of inertia 28 and the motor shaft 6.

Various minimization strategies can be applied.

The simplest one consists in calculating a large number of axes of inertia 28 of a virtual machine workpiece from a randomly moved virtual rough part, and selecting from the results the one with the smallest gap between the calculated axis of inertia 28 and the motor shaft 6.

The processing time can be reduced by using minimization methods of the Newton-Raphson type, which is known to persons skilled in the art, or any other similar digital method.

FIG. 7 shows the result of the processing leading to the optimum positioning of the actual rough part on the machining apparatus, which will be controlled from the file corresponding to the calculated position 28 in its latest iteration and the application of the machining constraints 2 to 5 which are the initial and unchanged constraints.

Optionally, subsequent steps of manufacturing quality control and tolerances are carried out in a known manner.

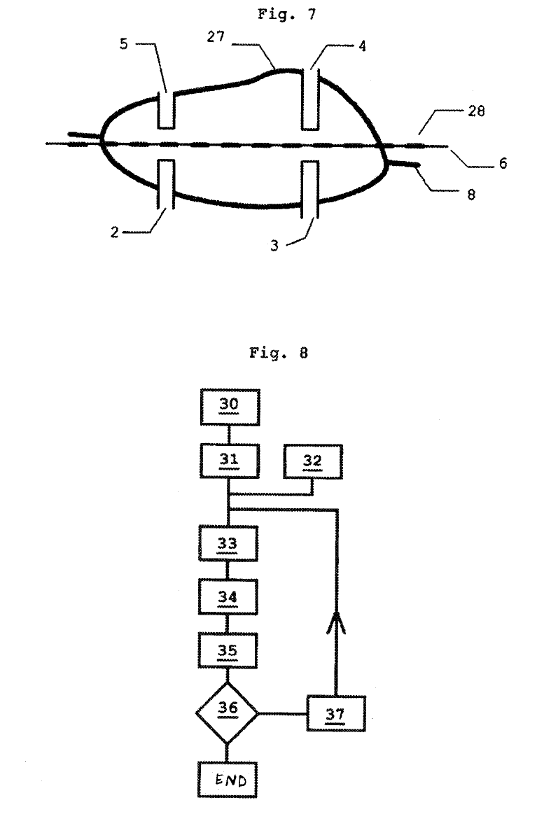

FIG. 8 shows the sequence of physical and digital processing operations implemented by the invention.

The first step 30 consists in manufacturing, by casting and forging, or any other technique, a rough part, the geometry of which corresponds to that of the target part with the best performance of the manufacturing process. Such rough part generally has imperfections related to the manufacturing process.

The next step 31 consists in digitizing such rough part. Such digitizing can be performed by physical sensors. But, in order to reduce the acquisition time, and increase the number of points, it is known and preferred to execute digitizing from one or more shooting(s) by digital cameras, so as to build a three-dimensional digital model 7.

For example, the article “Mesure 3D de formes et de déformations par stéréovision” (Jean-José ORTEU) published in the work “Techniques de l′Ingénieur, Traité de Génie Mécanique BM 7 015-1 and following”, describes a 3D method for acquiring a roughcast technique.

Machining instructions are also available as digital data 32.

The translation vector [Txᵢ, Tyᵢ, Tzᵢ] and the three Euler angles [Axᵢ, Byᵢ, Gzᵢ] corresponding to the initial positioning of the digital model 7 determined during step 31 are then initialized.

A virtual model is then calculated during a step 33 through a process which consists in moving the rough model 7 according to the transformation of the rigid body as defined by the vector [Txᵢ, Tyᵢ, Tzᵢ] and the rotation angles [Axᵢ, Byᵢ, Gzᵢ].

Such virtual model is then virtually machined during a step 34 which consists in applying the machining instructions as digital data 32 to the virtual model repositioned during the previous step. Such processing may for example be carried out using a platform of the CATIA type (trade name). The result of such processing is a three-dimensional digital model of an intermediate virtual part.

The next step 35 consists in calculating the axis of inertia 28 from the aforementioned intermediate virtual part, for example using the CATIA platform (trade name).

The calculated axis of inertia 28 is then compared with the motor shaft 6. If the discrepancy between these two axes is lower than a threshold value, the process ends.

If not so, the vector [Tx, Ty, Tz] and the rotation angles [Ax, By, Gz] are modified during a step 37 in order to determine a new position determined by a vector [Txⱼ, Tyⱼ, Tzⱼ] and the Euler angles [Axⱼ, Byⱼ, GZⱼ], optimized according to an optimization method.

All the processing operations corresponding to steps 33 to 36 are then executed.

The invention also relates to a machining apparatus comprising a processor controlled by a file obtained when implementing the method according to the invention.

The invention can also be implemented to carry out the balancing of a portion only of the rotating part. Such application is particularly useful for the processing of very long parts, or parts requiring a local balancing in addition to the overall balancing thereof, for example to achieve very high performance crankshafts.

In this case, the invention consists in controlling local removal of material to obtain a locally balanced model. For this purpose, the balancing in a limited portion is calculated on an intermediate virtual model. If this balancing appears imperfect, an additional machining constraint is determined for removing material in order to balance said local portion. Such additional machining will result in adding additional machining operations to the model of the virtual geometry of an intermediate part corresponding to the virtual machining operations 2 to 5. New iterations, taking into account such model with the additional machining operations will then be executed.

1-8. (canceled)

9. A method for balancing a rotating part in order to produce a machined and balanced rotating part, comprising areas machined with high tolerance and areas with low tolerance, whether machined or not from a blank of a rotating part on the one hand and a nominal digital model of machining constraints of the machined areas with low tolerances of a nominal rotating part on the other hand the method comprising:
an initial step of digitizing said blank for obtaining a digital model of said blank, in a predetermined reference frame;
virtually machining said digital model of the blank, so as to calculate an intermediate digital model in a target reference frame comprising at least one of a motor shaft of a rotating part machined from the digital model of the blank, and the nominal digital model of the machining constraints;
determining an axis of inertia of said intermediate digital model;
at least one step of modifying a geometric reference frame of said digital model of the blank so as to match said axis of inertia of said intermediate digital model with a nominal axis of rotation of the motor in the target reference frame;
steps of iterative calculation of the previous steps until the discrepancy between the calculated axis of inertia and a nominal motor shaft is lower than a threshold value; and
the final step consisting in controlling an actual machining apparatus in the target reference frame, from a nominal digital model of the machining constraints on an actual blank positioned on a machining apparatus in accordance with the intermediate digital model resulting from the last iteration.

10. The method for balancing a rotating part according to claim 9, wherein said step of modifying the geometric reference frame consists in recalculating a translation vector [Tx, Ty, Tz] and three Euler angles [Ax, By, Gz].

11. The method for balancing a rotating part according to claim 9, further comprising:
producing a rough part,
digitizing said rough part,
initializing a translation vector [Txᵢ, Tyᵢ, Tzᵢ] and three Euler angles [Axᵢ, Byᵢ, Gzᵢ] corresponding to an initial positioning of the digital model;
calculating a virtual model using a process comprising moving the rough model according to the transformation of a rigid body defined by the vector [Txᵢ, Tyᵢ, Tzᵢ] and rotation angles [Axᵢ, Byᵢ, Gzᵢ];
a step of virtual machining comprising applying machining instructions as digital data to the virtual model repositioned during the previous step;
calculating the axis of inertia from the intermediate virtual part;
comparing the calculated axis of inertia with the motor shaft and modifying, during a step of adjusting the vector [Tx, Ty, Tz] as well as the rotation angles [Ax, By, Gz] so as to determine a new position determined by a vector [Txⱼ, Tyⱼ, Tzⱼ] and by the Euler angles [Axⱼ, Byⱼ, GZⱼ], optimized according to a method for optimizing and iterating the set of processing operations.

12. The method for balancing a rotating part according to claim 9, further comprising:
calculating balancing in a limited portion and, if this balancing appears imperfect, of determining an additional machining constraint in addition to the original virtual machining operations, for removing material with an aim of balancing a local portion.

13. The method for balancing a rotating part according to claim 12, wherein new iterations, taking into account such model with the additional machining operations, are executed after calculation of the local portion balancing.

14. A machining apparatus comprising a processor controlled by a digital control obtained by implementing the method according to claim 9.

15. A computer program comprising program code instructions for executing the steps of the method according to claim 9, when said program is run on a computer.

16. A computer-readable recording medium, whereon a computer program is recorded, which comprises program code instructions for executing the steps of the method according to claim 9.
